(19) United States
(12) Patent Application Publication
(10) Pub. No.: US 2006/0213057 A1
(43) Pub. Date: Sep. 28, 2006

(54) Tool for disengaging electrical coupling

(76) Inventor: Raymond Pruitt, Harrison, AR (US)

Correspondence Address: LATHROP & GAGE LC, 1845 S. NATIONAL, P.O. BOX 4288, SPRINGFIELD, MO, 65101, US

(21) Appl. No.: 11/371,610

(22) Filed: Mar. 9, 2006

Related U.S. Application Data
(60) Provisional application No. 60/660,416, filed on Mar. 10, 2005.

(51) Int. Cl. B23P 19/00

(52) U.S. Cl. 29/759

(57) ABSTRACT

The present invention is a mechanical tool for disengaging an electrical plug from an electrical socket when the socket is provided with a cap and a retention tab which engages and retains the plug in place. The tool includes a handle portion and a grasping portion with the grasping portion having spaced apart legs and perpendicular stems. The legs of the grasping element are passed on either side of the plug and a skirt provided on either leg engages and moves upward the cap on the socket to disengage the socket tab from the plug. The plug can then be removed from the socket by forcibly levering the tool against the socket to extract the plug therefrom.

### RELATED APPLICATIONS

This application claims the priority to U.S. Patent Application Ser. No. 60/660,416 filed Mar. 10, 2005, the disclosure of which is incorporated herein by reference.

### BACKGROUND OF THE INVENTION

This invention relates to a tool for disengaging an electrical coupling or connection commonly found on vehicles, particularly large over-the-road trucks.

Large trucks are often equipped with multiple couplings, typically including various electrical couplings. These couplings may be found near or adjacent to the back of the cab of the truck or on the upper forward face of the trailer, but may also be found near or adjacent a fifth wheel coupling or near the tandem truck axles. When it is desired to disengage the electrical coupling, the operator may have to reach their arm underneath the trailer portion of the vehicle adjacent the fifth wheel coupling or actually climb up on the truck when the couplings are between the truck and trailer. Because of the size of these large trucks, it is often difficult to reach and grasp the electrical coupling to disengage it. Moreover, some danger is present with the operator placing their arm between the vehicle trailer and the fifth wheel connection point. When reaching to disengage the electrical coupling, the operator may also encounter hot metallic surfaces, dirt, grease and the like.

A variety of tools are known which can be used to disengage fifth wheel couplings which are generally releasably locked with a locking handle or pin. There are no known tools specifically designed, however, to allow an operator to disengage electrical couplings. Specifically, couplings which are generally found on large trucks include a female portion or socket solidly mounted to the vehicle. A male portion or plug is electrically connected to a plurality of wiring and, when the male portion is inserted into the female portion, a secure electrical connection is made allowing electrical connectivity between the truck and the trailer.

Because over-the-road trucks are subjected to a variety of weather elements and significant bouncing movement as they travel down the road, many electrical couplings include a locking mechanism which releasably secures the male portion within the female portion once it seated. A common locking mechanism includes a simple cap which substantially covers the female receptacle. It is generally hinged and rotatable upward to allow the male portion of the coupling to be inserted. It is often spring mounted so that it is self closing. The lower face or downward projecting portion of the cap includes a downward projecting tab.

The plug of the coupling only fits into the socket in a single orientation. The plug of the coupling has a locking mechanism which is a projection oriented generally upwards which is selectively secured by the downward projecting tab of the female receptacle cap.

To make the electrical connection, the cap of the socket is lifted and the plug oriented correctly and forcibly pushed into the socket of the receptacle. The cap is then lowered where upon the downward protruding tab engages the projection on the male portion of the coupling. Because of the downward spring force provided to the cap, it frictionally engages an outer surface of the male coupling and restricts undesired lateral movement of the plug which would result in an uncoupling.

While this orientation is preferable to limited unintentional uncoupling of the connection, the problem with this orientation is that to disengage the coupling, the spring loaded cap must be moved upward and away from the on the male portion of the coupling. The plug must simultaneously be pulled out of the socket. Because the operator is often crouched down and reaching between the trailer and the tandem axles to the fifth wheel coupling to access the electrical coupling, the operator generally can only use one arm to disengage this mechanism. Because the cap must be lifted at the same time the male portion is withdrawn, it is a very difficult task to perform with one arm.

The inventive tool described herein addresses this problem and provides a result thereto. The invention provides a novel tool for disengaging the described electrical coupling in a remote location, such as those often associated with over-the-road trucks.

### BRIEF DESCRIPTION OF DRAWINGS

FIG. 1 is a perspective view of the inventive tool and an associated workpiece.

FIG. 2 is a second perspective view of the inventive tool engaged in an operational orientation with a workpiece.

FIG. 3 is a partial perspective view of the inventive tool engaging a workpiece.

FIG. 4 is a partial perspective view of the inventive tool engaging a workpiece.

FIG. 5 is a side plan view of the inventive tool.

FIG. 6 is a bottom plan view of the inventive tool.

### DETAILED DESCRIPTION OF THE INVENTION

The inventive tool is preferably formed of a suitable rigid metal, although, it is to be understood that it could be formed of other materials, such as non-conductive fiberglass or other similar rigid materials. The tool is best understood with reference to a work piece and accordingly a description thereof is provided.

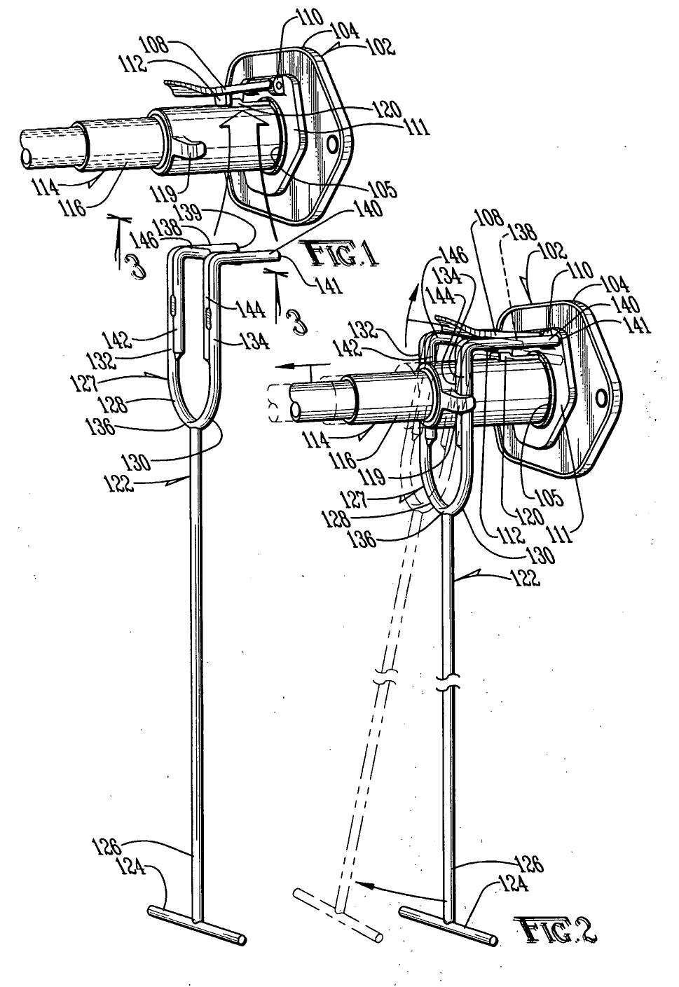

The tool is specifically intended for use to disengage an electrical coupling (work piece) typically found on over-the-road trucks. The coupling includes a female socket and male plug and is more particularly described herein. Referring now generally to FIGS. 1 and 2, an electrical socket 102 of the type generally mounted on an over-the-road truck so that electrical components of a trailer, such as refrigeration units and the like, can be connected to power supplies generally available on the tractor of the truck. The electrical socket has a housing 104 with a female electrical connector having a plurality of electrical pins (not shown). Because the pins can easily be damaged or rendered inoperable because of dirt and debris, a cap 108 is provided on the housing 104 to cover the pins. The cap 108 is generally connected to the housing 104 with a spring loaded hinge 110. The hinge 110 is generally quite resilient to forcibly close and retain the cap 108 flush with the housing 104 when the socket 102 is not in use. The cap 108 is generally provided with a tab 112 projecting generally toward the housing 104. Accordingly, when the cap 108 is in a closed position, the tab 112 is positioned within the female portion of the electrical socket 102. When the cap 108 is lifted to access the pins, the tab 112 is in a general downward orientation.

An electrical plug 114 comprises the male portion of the electrical connection and is configured for receipt into the socket 102. The plug 114 typically includes an elongated cylindrical body 116. At one end of the body 116, a plurality of receptacles are provided for the receipt of the pins on the socket 102. To form the electrical connection, the plug 114 is generally aligned with the socket 102 such that the receptacles (not shown) are in linear alignment with the pins. The plug 114 is simply moved in a linear manner to engage the pins into the receptacles. The body 116 further has a pair of opposed grips 119, positioned substantially adjacent the receptacles with one grip 119 on either side of the body 116. These grips 119 are utilized to grasp the plug 114 for forcible removal from the socket 102. The plug 114 further is provided with a projection 120 generally oriented upward when the plug 114 is mounted into the socket 102. When the plug 114 is positioned within the socket 102, the projection 120 is positioned between the downward depending tab 112 of the socket 102 and the opening 105. Because the cap 108 is spring loaded, it is forced generally downward such that the tab 112 engages the upward projection 120 of the plug 114 preventing it from being pulled out of the socket 102. Once the plug 114 has been positioned within the socket 102, it is necessary to lift the cap 108 to disengage the tab 112 from the upward projection 120 before the plug 114 can be removed. Generally, the removal of the plug 114 from socket 102 requires the use of both hands by an operator, one to lift the cap 108 to disengage tab 112 from the projection 120 and the second hand to forcibly pull the plug 114 from socket 102. The user typically grasp grips 119 to forcibly remove the plug 114 from socket 102.

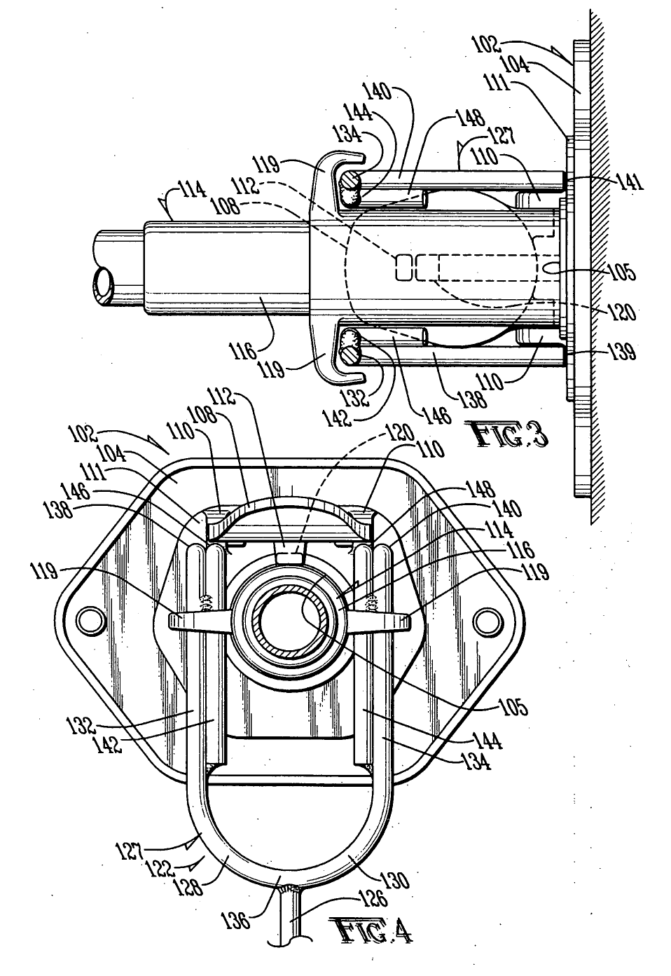

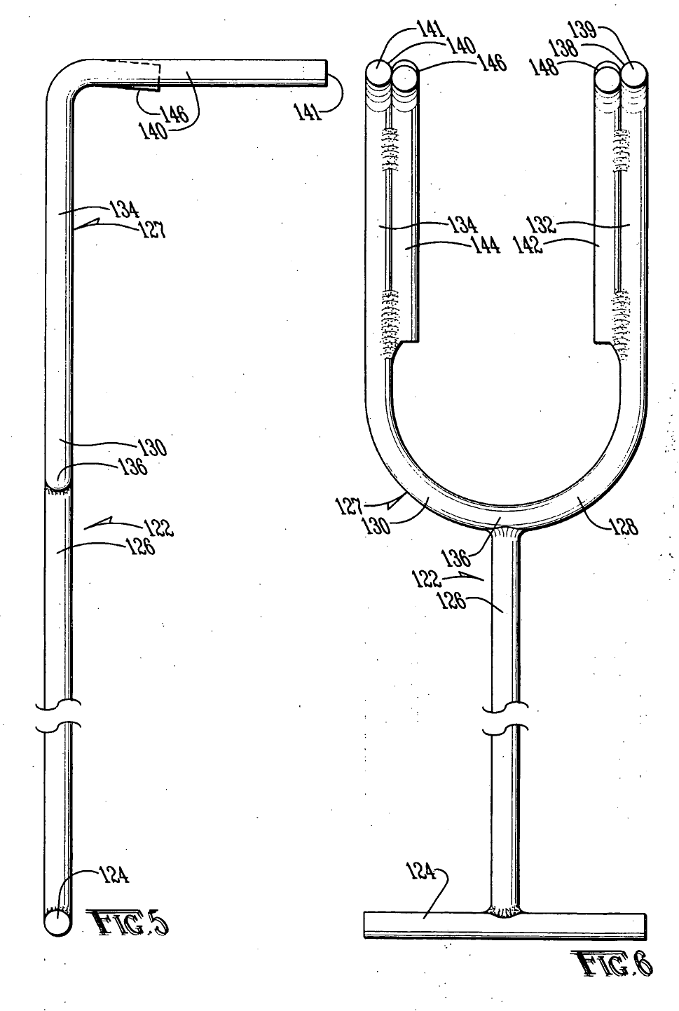

As shown in FIGS. 1, 2, 3 and 4, the uncoupling tool 122 is intended to assist the user in disengaging the plug 114 from the socket 102 and further alleviates the need to utilize both hands in accomplishing this task. The uncoupling tool 122 includes a gripable handle portion 124 and an elongated body 126 attached perpendicular to the handle 124. As best shown in FIGS. 5 and 6, the elongated tool body 126 includes a grasping element 127 distal the handle 124. The grasping element 127 is generally U-shaped and has a left shoulder 128 and a right shoulder 130 positioned on either side of the tool body 126. The left shoulder 128 extends into a left leg 132 opposing a right leg 134 which extends from the right shoulder 130. Accordingly, the left leg 132 is spaced apart from the right leg 134 with a bight 136 therebetween substantially adjacent the tool body 126. At the terminal end of left leg 132 is a stem 138 and at the terminal end of right leg 134 is a stem 140. The left stem 138 and the right stem 140 are generally oriented substantially perpendicular the left leg 132 and right leg 134 respectively. In combination, each of the legs and perpendicular stems form a cap engaging portion to the grasping element 127. The left stem 138 and right stem 140 are preferably from about two inches to about four inches in length.

The left leg 132 is provided with a skirt 142 oriented in generally inward respective the midline of the tool. Likewise, the right leg 134 is provided with a skirt 144 also oriented generally inward respective the midline of the tool. The left skirt 142 and right skirt 144 may be separately formed from the leg portions during the manufacturing process. However, it is preferable that the left skirt 142 and right skirt 144 be formed during manufacture by simply widening a portion of the left leg 132 and right leg 134. The left skirt 142 includes a stem 146 which is aligned with the left stem 138 of the left leg 132. Likewise, the right skirt 144 includes a stem 148 which is substantially aligned with the right stem 140 of the right leg 134. The skirt stems 146, 148 are oriented generally perpendicular to the left skirt 142 and right skirt 144 respectively. The skirt stems 146, 148 are slightly shorter in length than the stems 138, 140 of the legs 132, 134.

A standard plug 114 has a diameter of approximately one and one-half (1½) inches. The inner space between the left skirt 142 and right skirt 144 is slightly greater than one and one-half (1½) inches so that the grasping element 127 of the tool 122 can be positioned with the plug 114 between the skirts 142, 144. When the plug 114 is inserted in the socket 102, the distance between the socket 102 and the grips 119 is approximately two (2) inches.

To utilize the tool 122 to uncouple plug 114 from socket 102, the tool 122 is positioned with the plug 114 between the left leg 132 and right leg 134 of the tool 122. The end 139 of the left stem 138 and the end 141 of right stem 140 are positioned flush against the collar 111 of the socket 102. The stems 138, 140 are both approximately two (2) inches in length such that when the ends 139, 141 are positioned against the collar 111 of socket 102 the legs 132, 134 engage the grips 119 on the plug 114.

When the tool 122 is in position, the skirt stems 146, 148 engage the cap 108 on the socket 102. The leg stems 138, 140 are seated against the socket housing 104. As the tool 122 is pivoted generally upward from the socket 102, the skirt stems 146, 148 engage and urge the cap 108 generally upward away from plug 114 disengaging the tab 112 on the cap 108 from the projection 120 on the plug 114. As the handle 124 of the tool 122 continues to be pivoted generally outward away from socket 102, the skirt stems 146, 148 continue to move the cap 108 generally upward until the legs 132, 134 and associated skirts 142 and 144 engage the grips 119 on the plug 114. At this time, the handle is moved forcibly outward away from the socket 102 effectively jerking the plug 114 from the socket 102. Because the tab 112 of the socket 102 has been lifted away from the projection 120 on the plug 114 by the left and right stems 138, 140, the plug 114 can easily be jerked out of the socket 102. This can be accomplished with one hand by use of the uncoupling tool 122.

What is claimed is:

1. A tool for use in disengaging an electrical coupling of an over-the-road truck by engaging and unlocking a simple retention member, the tool compromising:
an elongate rigid handle,
a handle grip element secured to one end of the handle,
a substantially U-shaped member rigidly attached to the handle opposite the grip element,
said U-shaped member further comprising:
a first leg and spaced apart second leg having a bight there between, and
the first leg and second leg having stem portions, and
wherein the stem portions are oriented generally perpendicular to the first leg and second leg of the U-shaped member, and
wherein the first leg and second leg each have inwardly projecting skirts which span between a point substantially adjacent the bight and the stem portion of each arm and further wherein said U-shaped member is used to engage an electrical coupling such that the U-shaped member is passed between the male portion and female portion of an electrical coupling and rotated about its longitudinal axis so that the inwardly projecting portion engages and lifts a cap portion of the female coupling to disengage a downwardly projecting tab from an upward oriented projection mounted to the male coupling and wherein forcible lateral movement of the tool forcibly removes the male coupling from the female coupling.

2. A tool for disengaging an electrical coupling comprising:
an elongated body having a handle fixed perpendicularly thereto at a first end, and
a grasping element fixed at a second end;
the grasping element further comprising:
a U-shaped member with opposing legs and a bight therebetween,
the left leg including a perpendicularly mounted left stem and a right leg including a perpendicularly mounted right stem, and
wherein said tool is positioned to the electrical plug such that the plug is positioned between the left leg and right leg with the left stem and right stem engaging a surface on the socket such that outward levering of the tool against the surface of the socket forcibly withdraws the plug from the socket.

3. A tool for disengaging an electrical plug from a socket comprising:
a handle fixed perpendicularly to an elongated body, and
a grasping element fixed to the elongated body distal the handle, the grasping element further comprising:
a left leg and a spaced apart right leg with a bight therebetween, the left leg having a perpendicularly mounted stem and the right leg having a perpendicularly mounted stem,
a left skirt fixed to the left leg and oriented generally inward toward the bight,
a right skirt mounted to the right leg and oriented generally inward toward the bight, the left skirt having a perpendicularly mounted stem, and
the right skirt having a perpendicularly mounted stem.

4. The tool of claim 3 wherein the left skirt is integrally formed with the left leg and the right skirt is integrally formed with the right leg.

5. The tool of claim 3 wherein the left skirt is integrally formed with the left leg, the right skirt is integrally formed with the right leg, the stem of the left skirt is integrally formed with the stem of the left leg and the stem of the right skirt is integrally formed with the stem of the left leg.
